(19) United States
(12) Patent Application Publication
(10) Pub. No.: US 2010/0055395 A1
(43) Pub. Date: Mar. 4, 2010

(54) Method of Making Shaped Glass Articles

(76) Inventor: Ljerka Ukrainczyk, Painted Post, NY (US)

Correspondence Address: CORNING INCORPORATED, SP-TI-3-1, CORNING, NY, 14831, US

(21) Appl. No.: 12/251,698

(22) Filed: Oct. 15, 2008

Related U.S. Application Data
(60) Provisional application No. 61/092,550, filed on Aug. 28, 2008.

(51) Int. Cl. C03B 23/03

(52) U.S. Cl. 428/141; 65/106

(57) ABSTRACT

A method of making a shaped glass article includes applying a compression load to a surface of a glass sheet such that the compression load is distributed along a non-quality area of the glass sheet, wherein said non-quality area of the glass sheet circumscribes and adjoins one or more quality areas of the glass sheet. The method further includes holding the compression load against the surface of the glass sheet for a predetermined time during which a thickness of the glass sheet beneath the non-quality area decreases and the quality area protrudes outwardly relative to the surface of the glass sheet to form the shaped glass article.

### CROSS-REFERENCE TO RELATED APPLICATIONS

This application claims the benefit of priority under 35 U.S.C. §119(e) of U.S. Provisional Application Ser. No. 61/092,550 filed on Aug. 28, 2008.

### FIELD

The invention relates generally to methods and apparatus for making shaped objects. More specifically, the invention relates to a method for making a shaped glass article.

### BACKGROUND

Precision molding is suitable for forming shaped glass articles, particularly when the final glass article is required to have a high dimensional accuracy and a high-quality surface finish. In precision molding, a glass preform having an overall geometry similar to that of the final glass article is pressed between a pair of mold surfaces to form the final glass article. The process requires high accuracy in delivery of the glass preform to the molds as well as precision ground and polished mold surfaces and is therefore expensive. Press molding based on pressing a gob of molten glass into a desired shape with a plunger can be used to produce shaped glass articles at a relatively low cost, but generally not to the high tolerance and optical quality achievable with precision molding. Shaped glass articles formed from press molding a gob of molten glass may exhibit one or more of shear marking, warping, optical distortion due to low surface quality, and overall low dimensional precision.

### SUMMARY

In one aspect, the invention relates to a method of making a shaped glass article which comprises applying a first compression load to a first surface of a glass sheet such that the first compression load is distributed along a first surface non-quality area of the glass sheet, wherein said first surface non-quality area of the glass sheet circumscribes and adjoins one or more first surface quality areas of the glass sheet. The method further includes holding the first compression load against the first surface of the glass sheet for a predetermined time during which a thickness of the glass sheet beneath the first surface non-quality area decreases and the first surface quality area protrudes outwardly relative to the first surface of the glass sheet to form the shaped glass article.

In another aspect, the invention relates to a shaped glass article. The shaped glass article comprises a quality area, a non-quality area circumscribing the quality area, and a first surface. The first surface in the quality area protrudes outwardly relative to the first surface in the non-quality area.

Other features and advantages of the invention will be apparent from the following description and the appended claims.

### BRIEF DESCRIPTION OF DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain views of the figures may be shown exaggerated in scale or in schematic in the interest of clarity and conciseness.

FIG. 1A depicts a flowchart illustrating a method of making a shaped glass article

FIG. 1B depicts a second flowchart illustrating a method of making a shaped glass article.

FIG. 2 is a perspective view of a glass sheet for use in making a shaped glass article.

FIG. 3 is a cross-sectional view illustrating a first example of applying compression to a glass sheet.

FIG. 4 is a cross-sectional view illustrating a second example of applying compression to a glass sheet.

FIG. 5 is a cross-sectional view illustrating a third example of applying compression to a glass sheet.

FIG. 6 is a perspective view of a mold for compression-forming of shapes in a glass sheet.

FIG. 7 shows the glass-sheet/mold arrangement of FIG. 3 in a heated zone.

FIG. 8 depicts compression-forming of shapes in a glass sheet using the glass-sheet/mold arrangement shown in FIG. 3.

FIG. 9 depicts compression-forming of shapes in a glass sheet using the glass-sheet/mold arrangement shown in FIG. 4.

FIG. 10 depicts compression-forming of shapes in a glass sheet using the glass-sheet/mold arrangements shown in FIG. 5.

FIG. 11A is an example of a shaped glass article formed by the method of FIG. 1A.

FIG. 11B is a second example of a shaped glass article that could be formed by the method of FIG. 1A.

FIG. 12 is a graph of radius of curvature versus compression load.

FIG. 13 is a profilometer trace of a shape formed using the method of FIG. 1A.

### DETAILED DESCRIPTION

The invention will now be described in detail with reference to the accompanying drawings. In the detailed description, numerous specific details are set forth in order to provide a thorough understanding of the invention. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements.

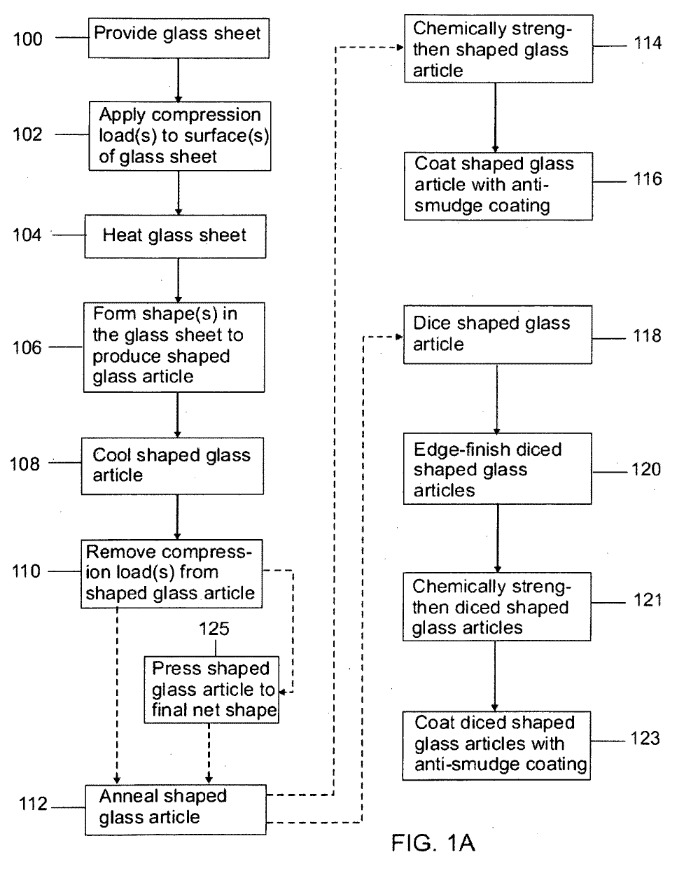

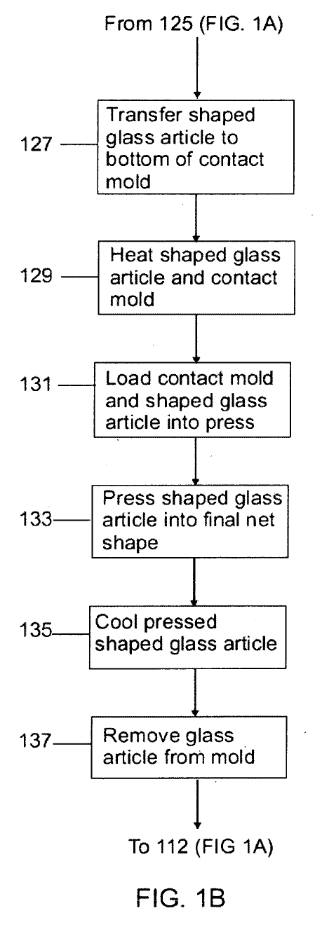

FIG. 1A is a flowchart illustrating a method of making a shaped glass article, which may have a single shaped portion or a plurality of shaped portions. A shaped glass article produced by the method of FIG. 1A may be used as-is or as a preform for a precision molding process. The method includes providing a glass sheet having a first surface and a second surface in opposing relation (100). The first surface may have a first surface non-quality area and one or more first surface quality areas, where the first surface non-quality area circumscribes and adjoins the first surface quality area(s). The second surface may have a second surface non-quality area and one or more second surface quality areas, where the second surface non-quality area circumscribes and adjoins the second surface quality area(s). The method includes applying a first compression load to the first surface (102). Where the first surface includes first surface quality area(s) and a first surface non-quality area, the first compression load is applied to the first surface non-quality area. Step 102 may also include applying a second compression load to the second surface. Where the second surface includes second surface quality area(s) and a second surface non-quality area, the second compression load is applied to the second surface non-quality area. The first and second compression loads may or may not be the same. The method includes heating the glass sheet to a temperature at which the viscosity of the glass sheet is below 10¹² Poise, preferably below 10¹⁰ Poise, more preferably below 10⁸ Poise (104). Heating of the glass sheet typically also includes heating of any objects in direct contact with the glass sheet.

The method includes forming shape(s) in the first surface by holding the first compression load against the first surface while maintaining the viscosity of the glass sheet below 10¹² Poise, preferably below 10¹⁰ Poise, more preferably below 10⁸ Poise (106). Where the first surface includes first surface quality area(s) and a first surface non-quality area, the shapes are formed in the first surface quality area(s). Step 106 may also include forming shape(s) in the second surface by holding the second compression load against the second surface while maintaining the viscosity of the glass sheet below 10¹² Poise, preferably below 10¹⁰ Poise, more preferably below 10⁸ Poise. Where the second surface includes second surface quality area(s) and a second surface non-quality area, the shapes are formed in the second surface quality area. The result of step 106 is a shaped glass article having one or more shaped portions.

The method includes cooling the shaped glass article to a temperature at which the viscosity of the glass is greater than 10¹³ Poise (108). The method includes removing the compression load(s) applied in step 106 from the shaped glass article (110). The method may include annealing the shaped glass article (112), chemically strengthening the annealed shaped glass article (114), and coating the final shaped glass article with an anti-smudge coating (116). Alternatively, for a shaped glass article including a plurality of shaped portions, the method may include annealing the shaped glass article (112), dicing the shaped glass article (118), edge-finishing the diced shaped glass articles (120), chemically strengthening the diced shaped glass articles (121), and coating the diced shaped glass articles with anti-smudge coating (123).

After removing the compression load(s) from the shaped glass article, as indicated at step 110, and before any of steps 112, 114, 116, 118, 120, 121, and 123 are performed, the shaped glass article may be pressed to achieve a final net shape (125). Any precision molding technique may be used to press the shaped glass article into the desired final net shape. In one example, as illustrated in FIG. 1B, the shaped glass article is transferred to the bottom of a contact mold (127). The shaped glass article and contact mold are heated to a temperature at which the viscosity of the glass is less than 10¹³ Poise (129). The contact mold, with the shaped glass article loaded therein, is then loaded into a press (131). The method includes pressing the shaped glass article into a final net shape (133) This may include pressing a precision-shaped surface, which may be provided by a high precision contact mold, against the shaped glass article to obtain a pressed part having the final desired dimensions and shape. After pressing, the shaped glass article is cooled to a temperature at which the viscosity of the glass is greater than 10¹³ Poise (135). The shaped glass article is then removed from the contact mold (137). The precision-pressed part may be further processed according to steps 112, 114, and 116 in FIG. 1A or steps 112, 118, 120, 121, 123 in FIG. 1A.

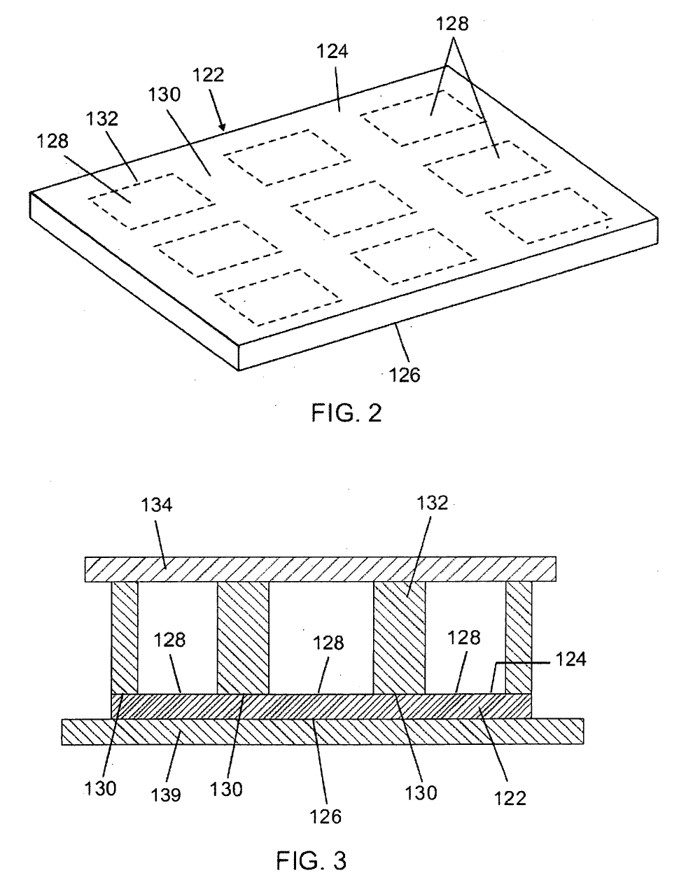

FIG. 2 illustrates step 100 of the method outlined in FIG. 1A. FIG. 2 depicts a glass sheet 122 having flat top and bottom surfaces 124, 126 (the bottom surface 126 is in opposing relation to the top surface 124). The top surface 124 may have one or more “quality areas” 128 circumscribed and adjoined by a “non-quality area” 130. In general, the term “quality area” is used to indicate the area of the glass sheet 122 where shapes will be formed and which will not be touched by a physical object, such as a mold, while the shapes are formed. The term “non-quality area” is used to indicate the area of the glass sheet 122 where shapes will not be formed and which can generally be touched by a physical object, such as a mold, while shapes are formed in the quality area(s). The dotted lines 132 used to demarcate the quality areas 128 are for illustration purposes and do not indicate that there are physical markings on the glass sheet 122 or that there are physical distinctions (or differential surface treatment) between the quality area(s) 128 and non-quality area 130 of the glass sheet 122. The quality areas 128 may have any desired outline shape, corresponding to the rim profile (or outline shape) of the shapes to be formed. The quality areas 128 may have the same or different outline shapes. The bottom surface 126 may also have quality/non-quality areas as described for the top surface 124. The arrangement of the quality/non-quality areas for the bottom surface 126 may or may not be the same as the one for the top surface 124. In general, the arrangement of the quality/non-quality areas will depend on where shapes are to be formed in the top surface 124 and bottom surface 126. The glass sheet 122 may be a cut piece of glass sheet as shown in FIG. 2 or may be a continuous sheet emerging, for example, from a glass forming device. The glass sheet may in some examples have a thickness selected from the range of 0.5 mm to 25 mm.

The glass sheet 122 may be formed using any suitable process for forming a sheet of glass, such as fusion draw process, slot draw process, or float process. The glass sheet 122 may be made from any glass composition suitable for the application in which the shaped glass articles are to be used. In one embodiment, the glass sheet 122 is made from a glass composition that is capable of being chemically strengthened by ion-exchange. Typically, the presence of small alkali ions such as Li+ and Na+ in the glass structure that can be exchanged for larger alkali ions such as K+ render the glass composition suitable for chemical strengthening by ion-exchange. The base glass composition can be variable. For example, U.S. patent application Ser. No. 11/888,213, assigned to the instant assignee, discloses alkali-aluminosilicate glasses that are capable of being strengthened by ion-exchange and down-drawn into sheets. The glasses have a melting temperature of less than about 1650° C. and a liquidus viscosity of at least 1.3×10⁵ Poise and, in one embodiment, greater than 2.5×10⁵ Poise. The glasses can be ion-exchanged at relatively low temperatures and to a depth of at least 30 μm. Compositionally the glass comprises: 64 mol %≦SiO₂≦68 mol %; 12 mol %≦Na₂O≦16 mol %; 8 mol %≦Al₂O₃≦12 mol %; 0 mol %≦B₂O₃≦3 mol %; 2 mol %≦K₂O≦5 mol %; 4 mol %≦MgO≦6 mol %; and 0 mol %≦CaO≦5 mol %, wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)−Al₂O₃≦2 mol %; 2 mol %≦Na₂O−Al₂O₃≦6 mol %; and 4 mol %≦(Na₂O+K₂O)−Al₂O₃≦10 mol %.

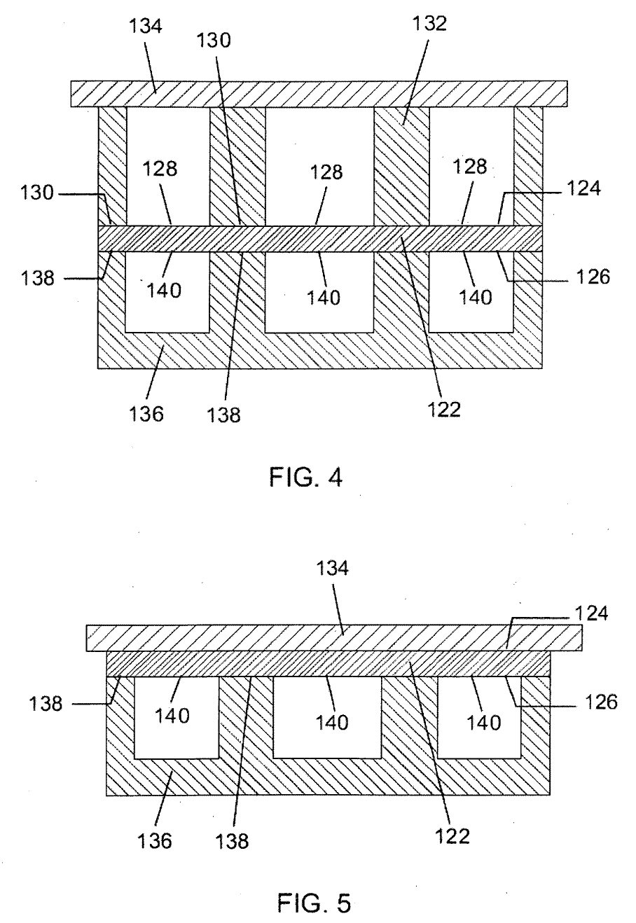

FIGS. 3-5 illustrate how step 102 of the method outlined in FIG. 1A may be implemented physically. In FIG. 3, a glass sheet 122 is placed on a bottom setter plate 139. The bottom setter plate 139 may be any suitable heat-resistant material that will not chemically react with the glass sheet 122 under the conditions in which shapes will be formed in the glass sheet 122, such as high temperature steel, cast iron, or ceramic. Top mold 132 is placed on top of the glass sheet 122 and used to apply a compression load to the top surface 124 of the glass sheet 122. The compression load is applied only where the top mold 132 contacts the top surface 124. In the example shown in FIG. 3, the top mold 132 contacts the top surface 124 in the non-quality area 130. The weight of the top mold 132 serves as the compression load that is applied to the top surface 124 of the glass sheet 122. The compression load is distributed along the non-quality area 130. If the weight of the top mold 132 is insufficient to provide the desired compression load, a weight member 134 may be mounted on the top mold 132 to augment the compression load provided by the top mold 132. Referring to FIG. 4, the bottom setter plate (139 in FIG. 3) may be replaced with bottom mold 136 to allow shapes to be formed on the bottom surface 126 of the glass sheet 122. The structure of bottom mold 136 may be the same or different from the structure of the top mold 132. Bottom mold 136 contacts the bottom surface 126 of the glass sheet 122 in the non-quality area 138 but not in the quality areas 140. The compression load applied to the top surface 124 of the glass sheet 122 (by top mold 132 and optionally weight member 134) is transmitted to the bottom surface 126 of the glass sheet 122 and applied to the non-quality area 138 via contact with the bottom mold 136. The arrangement in FIG. 4 allows shapes to be formed on the top and bottom surfaces 124, 126 of the glass sheet 122 simultaneously. Referring to FIG. 5, glass sheet 122 may be placed on bottom mold 136 and weight member 134 may be placed directly on the top surface 124 of the glass sheet 122, i.e., without the intervention of the top mold (132 in FIG. 4). As in FIG. 4, the compression load provided by the weight member 134 is transmitted to the bottom surface 126 of the glass sheet 122 and applied to the non-quality area 138 via contact with bottom mold 136.

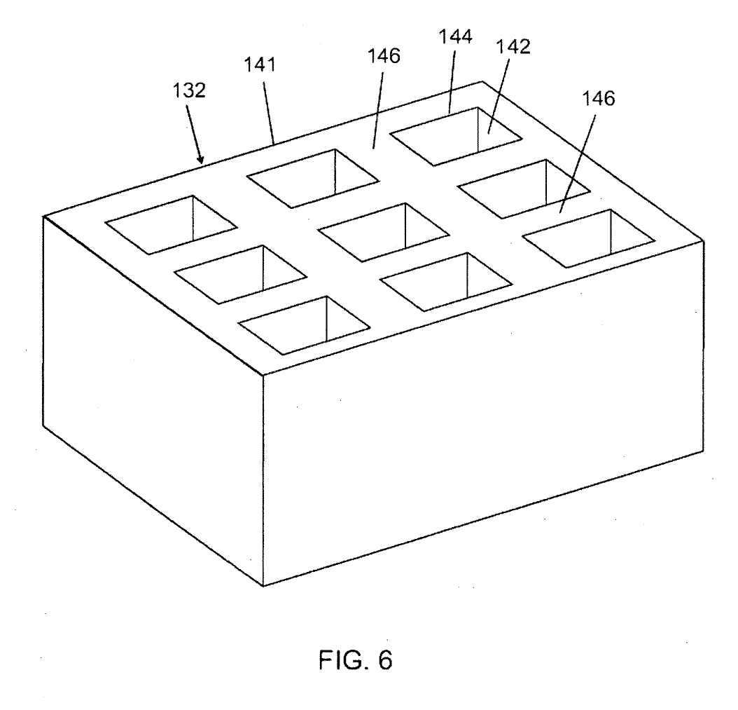

FIG. 6 is a perspective view of mold 132 having mold body 141 in which channels 142 are formed. Each channel 142 has a rim profile 144 that determines the rim profile of a shape to be formed at that channel. The channel in the mold body 141 may have similar or different rim profiles and dimensions. FIG. 6 shows rim profile 144 as being rectangular. However, the invention is not limited to a rim profile having a rectangular shape. In general, rim profile 144 is determined by the rim profile of the shape to be formed. The channels 142 are separated or circumscribed or defined by interconnected webs 146 formed in the mold body 141. Mold 132 contacts the surface of the glass sheet (122 in FIGS. 3 and 4) via the interconnected webs 146. Mold 132 may be made of a heat-resistant material, preferably one that would not react with the material of the glass sheet under the conditions at which the shaped glass article is made. As an example, the mold 132 may be made of high-temperature steel, cast iron, or ceramic. To extend the life of the mold 132, the outer surfaces of the interconnected webs 146 that would come into contact with the glass sheet may be coated with a high-temperature material that would not react with the glass sheet, e.g., diamond chromium coating. Channels 142 may be through-holes in the mold body 141 or may be cavities in the mold body 141. The description above with respect to top mold 132 also applies to bottom mold (136 in FIGS. 4 and 5).

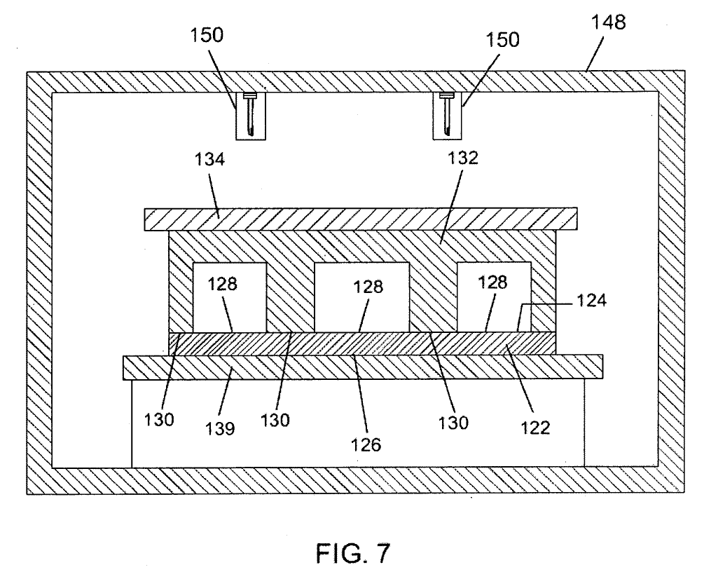

Referring to FIG. 1A, step 104 requires heating of the glass sheet. As previously described, heating of the glass sheet typically includes heating the glass sheet to a temperature at which the viscosity of the glass is lower than 10¹² Poise, preferably lower than 10¹⁰ Poise, and, more preferably, lower than 10⁸ Poise. The step of heating the glass sheet may occur before or after the compression load is applied to the glass sheet. In other words, the glass sheet may be hot or cold when assembled with mold(s) as in, for example, FIGS. 3-5. The glass sheet may be hot if it is being transported directly from a glass sheet forming device. Regardless of the initial state of the glass sheet, the glass sheet would need to be hot and maintained in a hot state during step 106, where the shapes are formed in the glass sheet. By hot, it is meant that the glass sheet is at a temperature at which the viscosity of the glass is lower than 10¹² Poise, preferably lower than 10¹⁰ Poise, and, more preferably, lower than 10⁸ Poise. Thus, steps 104 and 106 may be combined, and, as illustrated in FIG. 7, may take place in a heated zone or furnace 148 equipped with appropriate heating elements 150.

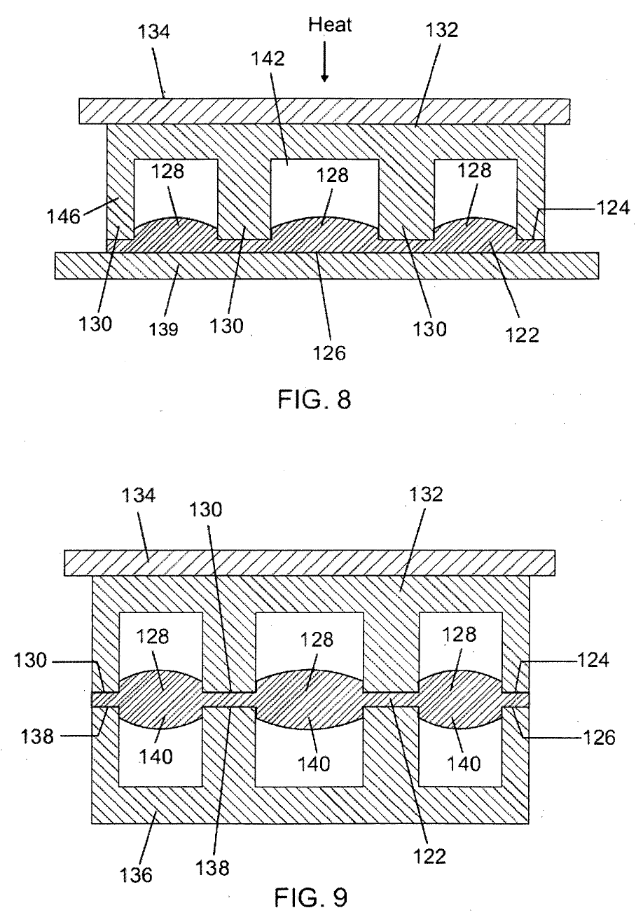

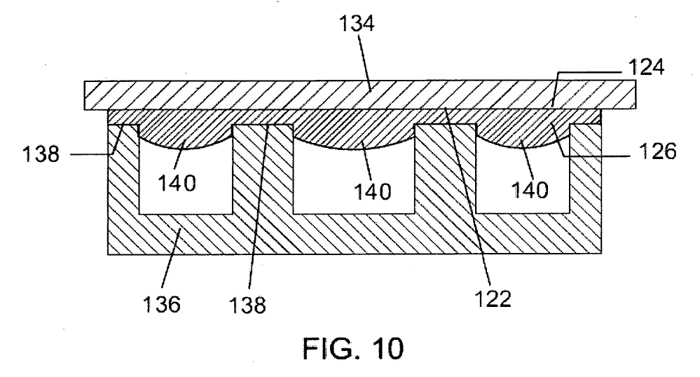

FIGS. 8-10 illustrate what happens when compression load is applied to the glass sheet while the glass sheet is hot, as explained above, for a predetermined time period. The time period during which the compression load is applied to the glass sheet is determined experimentally for a given glass viscosity, glass thickness, and load applied. The longer the load time at fixed glass viscosity, glass thickness, and compression load, the higher the outward protrusion of glass in the non-contact area. FIGS. 8-10 correspond to the glass-sheet/mold arrangements depicted in FIGS. 3-5, respectively. In FIG. 8, under the compression load provided by the mold 132 (and weight member 134 if used), the thickness of the glass sheet 122 underneath the non-quality area 130 (i.e., the portion of the glass sheet 122 trapped between the interconnected webs 146 of mold 132 and bottom setter plate 139) decreases. The material underneath the non-quality area 130 is squeezed into the adjoining quality areas 128, thereby causing the quality areas 128 to protrude outwardly relative to the top surface 124, or into the mold channels (or cavities) 142, to form the desired shapes in the glass sheet 122. FIG. 9 shows a compression-forming process similar to that depicted in FIG. 8, except that in FIG. 9 the glass sheet also protrudes outwardly into cavities 136a in the bottom mold 136 so that the resulting glass article has protruding shapes on both surfaces of the glass sheet 122. In FIG. 10, shapes are formed on the bottom surface 126 of the glass sheet 122, as described above, while the top surface 124 remains flat. The glass sheet 122 having the shapes formed on one or both of its top and bottom surfaces 124, 126 may be referred to as a shaped glass article. In the examples shown in FIGS. 8-10, the shaped glass article has a plurality of shaped portions. In alternate examples, the shaped glass article may have only a single shaped portion.

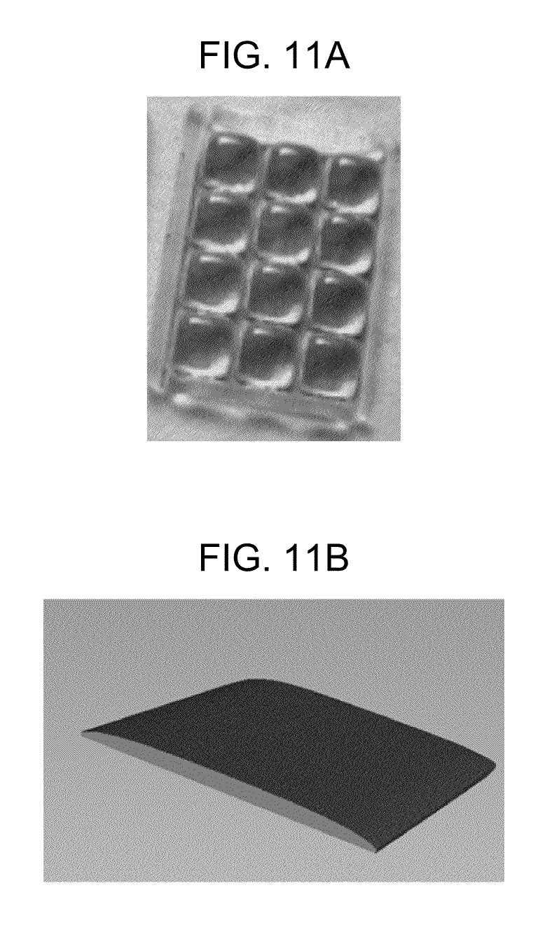

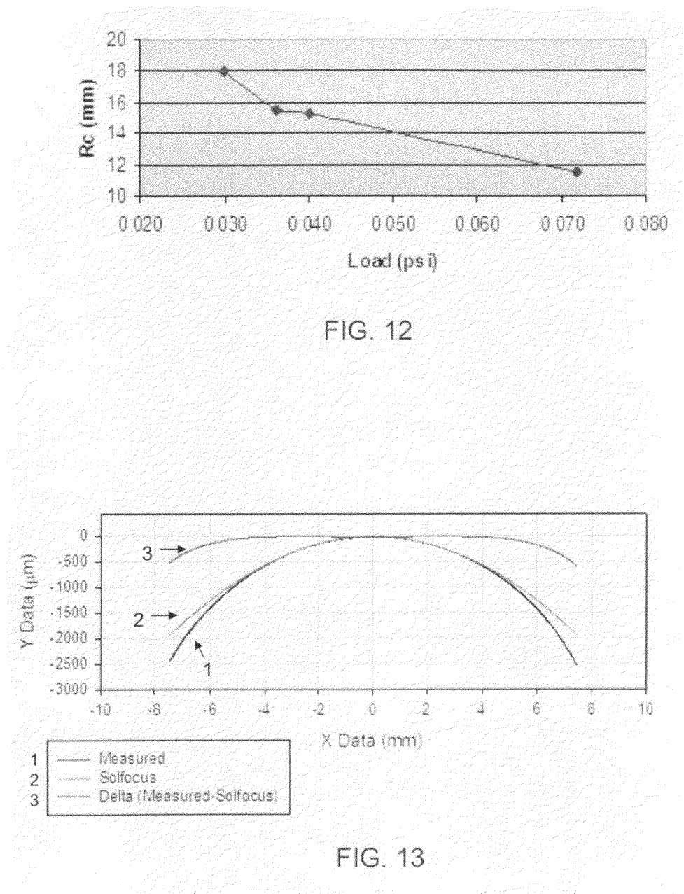

Various parameters determine the extent to which the glass sheet 122 protrudes outwardly into the mold channels 142 and the shape it forms when it protrudes outwardly into the mold channels 142. Such parameters include the glass viscosity when the compression load is applied, the length of time for which the compression is load, the surface tension of the glass, the amount of compression load, the shape of the mold channels, the thickness of the glass sheet, and the thermal cycle, e.g., the heat-up rate or cool-down rate. FIG. 11A is an example of a shaped glass article formed by the method outlined above. The starting glass thickness was 7 mm, holding temperature was 770° C., compression load was 0.07 psi, and holding tine was 5 minutes. The glass was Schott B270. FIG. 11B is an example of a shaped glass article that could be made from the method outlined above using glass sheet with a thickness of about 2 mm. In this example, the shapes are formed as described above, followed by mechanical grinding and polishing of the planar sides of the article. The shape in FIG. 11B could be formed as a symmetrical part (using, for example, the setup shown in FIGS. 4 and 9), which is then sawed in half. Symmetrical as well as asymmetrical shapes can be formed using the method described above. FIG. 12 shows a graph of radius of curvature (of a shaped portion of a glass sheet) versus compression load (applied to a surface of the glass sheet) assuming a constant thermal profile. Based on FIG. 12, radius of curvature has an inversely proportional relationship to compression load. FIG. 13 is a profilometer trace of a shape formed using the method described above. FIG. 13 shows that aspheric shapes can be formed using the method described above.

Returning to FIG. 1A, once the shapes are formed in the glass sheet as described above, the shaped glass article is cooled as indicated in step 108. Cooling may be by exposing the shaped glass article to ambient air or may include circulating cooling air or gas around the shaped glass article. Typically, the shaped glass article is cooled down while still in contact with the mold(s). Annealing of the shaped glass article, as indicated in step 112, may be in any suitable annealing oven and using the appropriate annealing schedule for the glass composition. Chemical strengthening, as indicated in steps 114 and 121, may be by ion-exchange. The ion-exchange process typically occurs at an elevated temperature range that does not exceed the transition temperature of the glass. The glass is dipped into a molten bath comprising a salt of an alkali metal, the alkali metal having an ionic radius that is larger than that of the alkali metal ions contained in the glass. The smaller alkali metal ions in the glass are exchanged for the larger alkali ions. For example, a glass sheet containing sodium ions may be immersed in a bath of molten potassium nitrate (KNO₃). The larger potassium ions present in the molten bath will replace smaller sodium ions in the glass. The presence of the large potassium ions at sites formerly occupied by sodium ions creates a compressive stress at or near the surface of the glass. The glass is then cooled following ion exchange. The depth of the ion-exchange in the glass is controlled by the glass composition. For potassium/sodium ion-exchange process, for example, the elevated temperature at which the ion-exchange occurs can be in a range from 390° C. to 430° C., and the time period for which the sodium-based glass is dipped in a molten bath comprising a salt of potassium can be 7 to 12 hours (less time at high temperature, more time at lower temperature). In general, the deeper the ion-exchange, the higher the surface compression and the stronger the glass. In step 118, any suitable cutting tool may be used to dice the shaped glass article into individual shaped glass articles. In step 120, techniques such as fire-polishing may be used to finish the diced shaped glass articles. Between steps 112 and 114, the glass sheet including the shaped portion(s) can be trimmed as necessary and finished.

In the method outlined above, the shaped glass article can be formed without contacting the quality area. This means that the shaped glass article can have a very high surface quality. In fact, the glass surface quality is improved compared to the parent glass sheet because additional heat treatment at high temperature heals surface glass defects. In one example, a glass sheet made from soda lime glass using a float process had a surface roughness (Ra) of 6 nm. After shapes were formed in the glass sheet using the method outlined in FIG. 1A, the surface roughness (Ra) was reduced to 0.3 nm.

A shaped glass article formed using the method above can also serve as a preform for contact-pressing to obtain a higher dimensional precision on the final part. Using this approach, complex shapes can be easily formed at low cost to near net shape (using the method outlined in FIG. 1) so that the final dimensioning to precision shape with a high-cost precision mold with optical quality coatings only requires a very short contact time. The life of such a high-cost precision mold can therefore be much longer.

The method described above can be used to make arrays of optics, or other shapes where high surface finish and precision are desired. The method described above can also be used to make discrete parts by dicing arrays formed in the glass sheet into individual parts. With the method described above, shapes can be formed on one or both surfaces of the glass sheet. The method described can also be implemented as an inline process, where a glass sheet is received from a glass forming device and processed as outlined in FIGS. 1A and 1B. The inline process can take advantage of the glass already being hot, thereby reducing the cost of the process.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of making a shaped glass article, comprising:
applying a first compression load to a first surface of a glass sheet such that the first compression load is distributed along a first surface non-quality area of the glass sheet, wherein said first surface non-quality area of the glass sheet circumscribes and adjoins one or more first surface quality areas of the glass sheet; and
holding the first compression load against the first surface of the glass sheet for a predetermined time during which a thickness of the glass sheet beneath the first surface non-quality area decreases and the first surface quality area protrudes outwardly relative to the first surface of the glass sheet to form the shaped glass article.

2. The method of claim 1, further comprising heating the glass sheet to a temperature at which the glass sheet has a viscosity lower than 10¹² Poise prior to holding the compression load against the first surface.

3. The method of claim 1, wherein holding the first compression load occurs while the viscosity of the glass sheet is lower than 10¹² Poise.

4. The method of claim 1, wherein holding the first compression load occurs while the viscosity of the glass sheet is lower than 10⁸ Poise.

5. The method of claim 1, wherein applying the first compression load to the first surface of the glass sheet comprises contacting the first surface of the glass sheet with a mold that contacts the first surface at only the non-quality area.

6. The method of claim 5, wherein applying the first compression load to the first surface of the glass sheet further comprises mounting a weight member on the mold to augment the first compression load.

7. The method of claim 1, further comprising cooling the shaped glass article to a temperature at which the viscosity of the shaped glass article is greater than 10¹³ Poise.

8. The method of claim 7, further comprising removing the first compression load from the shaped glass article.

9. The method of claim 8, further comprising annealing the shaped glass article.

10. The method of claim 9, further comprising chemically strengthening the shaped glass article.

11. The method of claim 10, wherein the shaped glass article is strengthened by ion exchange.

12. The method of claim 11, wherein the shaped glass article is ion exchanged to a depth of at least 30 μm from the first surface.

13. The method of claim 8, further comprising coating the shaped glass article with anti-smudge coating.

14. The method of claim 7, further comprising pressing the shaped glass article to a final net shape by bringing the shaped glass article in contact with a precision molding surface.

15. The method of claim 1, further comprising applying a second compression load to a second surface of the glass sheet such that the second compression load is distributed along a second surface non-quality area of the glass sheet, wherein said second surface non-quality area of the glass sheet circumscribes and adjoins one or more second surface quality areas of the glass sheet.

16. The method of claim 15, wherein the first compression load and second compression load are applied simultaneously to the first surface and second surface, respectively.

17. The method of claim 15, further comprising holding the second compression load against the second surface of the glass sheet for a predetermined time during which a thickness of the glass sheet beneath the second surface non-quality area decreases and the second surface quality area protrudes outwardly relative to the second surface of the glass sheet to form the shaped glass article.

18. The method of claim 1, wherein the glass is an alkali aluminosilicate glass.

19. The method of claim 18, wherein the alkali aluminosilicate glass comprises 64 mol %≦SiO₂≦68 mol %; 12 mol %≦Na₂O≦16 mol %; 8 mol %≦Al₂O₃≦12 mol %; 0 mol %≦B₂O₃≦3 mol %; 2 mol %≦K₂O≦5 mol %; 4 mol %≦MgO≦6 mol %; and 0 mol %≦CaO≦5 mol %, wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)−Al₂O₃≦2 mol %; 2 mol %≦Na₂O−Al₂O₃≦6 mol %; and 4 mol %≦(Na₂O+K₂O)−Al₂O₃≦10 mol %.

20. The method of claim 1, wherein the glass sheet is formed by one of a fusion draw process, a slot draw process, and a float process.

21. The method of claim 20, wherein the glass sheet has a surface roughness of up to about 0.3 nm.

22. The method of claim 1, further comprising dicing the shaped glass article to form a plurality of shaped glass articles.

23. The method of claim 22, further comprising polishing the at least one surface of each of the plurality of shaped glass articles.

24. The method of claim 22, further comprising finishing at least one edge of each of the plurality of shaped glass articles.

25. A shaped glass article, the shaped glass article comprising a quality area, a non-quality area circumscribing the quality area, and a first surface, wherein the first surface in the quality area protrudes outwardly relative to the first surface in the non-quality area.
